(19) United States
(12) Patent Application Publication
(10) Pub. No.: US 2025/0193840 A1
(43) Pub. Date: Jun. 12, 2025

(54) METHOD FOR DATA MATCHING, READABLE MEDIUM AND ELECTRONIC DEVICE

(71) Applicant: Beijing Bytedance Network Technology Co., Ltd., Beijing (CN)

(72) Inventor: Xin SHU, Beijing (CN)

(21) Appl. No.: 18/838,925

(22) PCT Filed: May 16, 2023
(86) PCT No.: PCT/CN2023/094431

§ 371 Date: Aug. 15, 2024

(30) Foreign Application Priority Data
May 23, 2022 (CN) 202210567652.8

(51) Int. Cl. H04W 64/00; H04L 41/16; H04W 48/16

(52) U.S. Cl. CPC H04W 64/003; H04L 41/16; H04W 48/16

(57) ABSTRACT

A method for data matching, a readable medium and an electronic device are provided. The method includes: acquiring a target location corresponding to each target wireless network of a plurality of target wireless networks, and at least one point of interest to be matched within a preset range of the target location; calculating relationship matching feature data between each target wireless network and the at least one point of interest to be matched that corresponds to the target wireless network; inputting the relationship matching feature data into a preset link prediction model to determine a target point of interest corresponding to the target wireless network; and determining at least one of the target wireless networks corresponding to the target point of interest according to the relationship matching feature data and the first identification information of each target wireless network.

### CROSS-REFERENCE TO RELATED APPLICATION(S)

The present application claims priority of the Chinese Patent Application No. 202210567652.8 filed on May 23, 2022, the disclosure of which is incorporated herein by reference in its entirety as part of the present application.

### TECHNICAL FIELD

Embodiments of the present disclosure relate to a method and apparatus for data matching, a readable medium, and an electronic device.

### BACKGROUND

In a geographic information system, a points of interest (POI) refers generally to a geographical object that may be abstracted as a point, including schools, banks, shops, bus stations, etc. Identifying an association relationship between a point of interest and a wireless network (e.g., Wireless Fidelity (Wi-Fi), Bluetooth, etc.) can usually provide a user with better services. For example, when user authorization is received, the user's visit to a shop may be determined based on a wireless network to which the user is connected, or the user may be accurately positioned when a Global Positioning System (GPS) signal is poor. However, the current identification of an association relationship between a point of interest and a wireless network usually has the problems of poor identification accuracy and low identification rate.

### SUMMARY

This summary is provided to give a brief overview of concepts, which will be described in detail later in the section of Detailed Description. This summary is neither intended to identify key or necessary features of the claimed technical solutions, nor is it intended to be used to limit the scope of the claimed technical solutions.

The present disclosure provides a method and apparatus for data matching, and a readable medium.

In the first aspect, the present disclosure provides a method for data matching. The method includes:
acquiring a target location corresponding to each target wireless network of a plurality of target wireless networks, and at least one point of interest to be matched within a preset range of the target location;
calculating relationship matching feature data between each target wireless network and the at least one point of interest to be matched that corresponds to the target wireless network;
inputting the relationship matching feature data into a preset link prediction model to determine a target point of interest corresponding to the target wireless network; and
determining at least one of the target wireless networks corresponding to the target point of interest according to the relationship matching feature data and first identification information of each target wireless network.

In the second aspect, the present disclosure provides an apparatus for data matching. The apparatus includes the first acquisition module, the second acquisition module, the first determination module and the second determination module.

The first acquisition module is configured to acquire a target location of each target wireless network of a plurality of target wireless networks, and at least one point of interest to be matched within a preset range of the target location.

The second acquisition module is configured to calculate relationship matching feature data between each target wireless network and the at least one point of interest to be matched that corresponds to the target wireless network.

The first determination module is configured to input the relationship matching feature data into a preset link prediction model to determine a target point of interest corresponding to the target wireless network.

The second determination module is configured to determine at least one of the target wireless networks corresponding to the target point of interest according to the relationship matching feature data and first identification information of each target wireless network.

In the third aspect, the present disclosure provides a computer-readable medium, which stores a computer program. When the program is executed by a processor, the steps of the method in the first aspect are implemented.

In the fourth aspect, the present disclosure provides an electronic device. The electronic device includes a memory and a processor. A computer program is stored in the memory. The processor is configured to execute the computer program in the memory to implement the steps of the method in the first aspect.

The above technical solution is performed by calculating relationship matching feature data between each target wireless network and the point of interest to be matched that corresponds to the target wireless network; inputting the relationship matching feature data into the preset link prediction model to determine the target point of interest corresponding to the target wireless network; and determining the at least one target wireless network corresponding to the target point of interest according to the relationship matching feature data and the first identification information of each target wireless network. In this way, the target point of interest corresponding to the target wireless network can be accurately identified, and at least one target wireless network corresponding to the target point of interest can also be effectively acquired, which can effectively improve the identification rate of the association relationship between the target wireless network and the target point of interest, and ensure the accuracy of identification results.

The other features and advantages of the present disclosure will be described in detail in the following section of Detailed Description.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale. In the accompanying drawings:

FIG. 1 is a flowchart of a method for data matching illustrated by an exemplary embodiment of the present disclosure;

FIG. 2 is a schematic diagram of a method for data matching illustrated by an exemplary embodiment of the present disclosure;

FIG. 3 is a schematic diagram of a method for data matching illustrated by another exemplary embodiment of the present disclosure;

FIG. 4 is a schematic diagram of a method for data matching illustrated by yet another exemplary embodiment of the present disclosure;

FIG. 5 is a schematic diagram of a method for data matching illustrated by yet another exemplary embodiment of the present disclosure;

FIG. 6 is a flowchart of a method for data matching according to the embodiment illustrated in FIG. 1 of the present disclosure;

FIG. 7 is a schematic diagram of a workflow of a preset link prediction model illustrated by an exemplary embodiment of the present disclosure;

FIG. 8 is a flowchart of a method for data matching according to the embodiment illustrated in FIG. 1 of the present disclosure;

FIG. 9 is a schematic diagram of a method for data matching illustrated by yet another exemplary embodiment of the present disclosure;

FIG. 10 is a schematic diagram of a method for data matching illustrated by yet another exemplary embodiment of the present disclosure;

FIG. 11 is a block diagram of an apparatus for data matching illustrated by an exemplary embodiment of the present disclosure;

FIG. 12 is a block diagram of an apparatus for data matching according to the embodiment illustrated in FIG. 11 of the present disclosure; and

FIG. 13 is a block diagram of an electronic device illustrated by an exemplary embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from a user, prompt information is sent to the user to clearly inform the user that a requested operation will require access to and use of personal information of the user, so that the user can independently choose, according to the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

Simultaneously, it can be understood that the data involved in the technical solutions (including, but not limited to, the data itself and the access to or use of the data) shall comply with the requirements of corresponding laws, regulations, and relevant provisions.

Before specific implementations of the present disclosure are described in detail, an application scenario of the present disclosure is first described as follows. The present disclosure may be applied to a scenario, where a POI in which a user is located is determined based on a wireless network to which the user is connected, or where a wireless network (e.g., Wi-Fi, Bluetooth, etc.) corresponding to a POI in which a user is located is acquired based on the POI. In the related art, the method usually used in identifying a wireless network associated with a POI is: acquiring a longitude and latitude, a name, etc. of the point of interest, and acquiring a longitude and latitude, a Service Set Identifier (SSID), etc. of the wireless network. When a distance between the latitude and longitude of the point of interest and the latitude and longitude of the wireless network is less than a radius of a wireless signal transmitted by the wireless network, and a similarity between the SSID of the wireless network and the name of the point of interest is greater than a preset threshold, then it is determined that there is an association relationship between the point of interest and the wireless network. However, the SSID of the wireless network may be set randomly by the user, and due to different expressions in Chinese and English, abbreviations, etc., the phenomenon that the association relationship between the point of interest and the wireless network cannot be identified or be identified incorrectly is likely to be caused, that is, the current method for data matching has the problems of low identification rate and poor identification accuracy.

To solve the above technical problem, the present disclosure provides a method and apparatus for data matching, a readable medium and an electronic device. The method is performed by respectively calculating relationship matching feature data between each of target wireless networks and a point of interest to be matched that corresponds to the target wireless network; inputting the relationship matching feature data into a preset link prediction model to determine a target point of interest corresponding to the target wireless network; and determining at least one target wireless network corresponding to the target point of interest according to the relationship matching feature data and the first identification information of the target wireless networks. Thus, the target point of interest corresponding to the target wireless network can be accurately identified, and at least one target wireless network corresponding to the target point of interest can also be effectively acquired, which can effectively improve the identification rate of the association relationship between the target wireless network and the target point of interest, and ensure the accuracy of identification results.

The following describes the technical solutions of the present disclosure in detail with reference to specific embodiments.

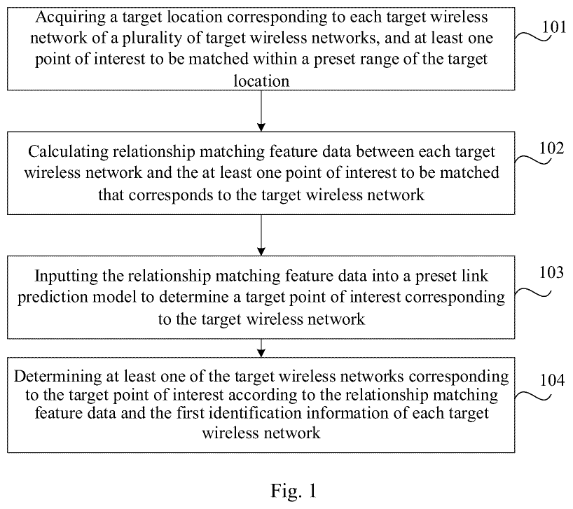

FIG. 1 is a flowchart of a method for data matching illustrated by an exemplary embodiment of the present disclosure. As shown in FIG. 1, the method may include the following steps.

Step 101: acquiring a target location corresponding to each target wireless network of a plurality of target wireless networks, and at least one point of interest to be matched within a preset range of the target location.

The target wireless network may be Wi-Fi or Bluetooth, and the target location of the target wireless network may be a longitude and latitude of the target wireless network.

In the step 101, the target location of each target wireless network may be acquired from a pre-stored wireless network database, and the wireless network database includes a longitude and latitude of each wireless network.

In addition, a point of interest whose distance from the target location is less than or equal to a preset distance threshold may be acquired from a preset set of points of interest, and the point of interest is taken as a point of interest to be matched that corresponds to the target wireless network.

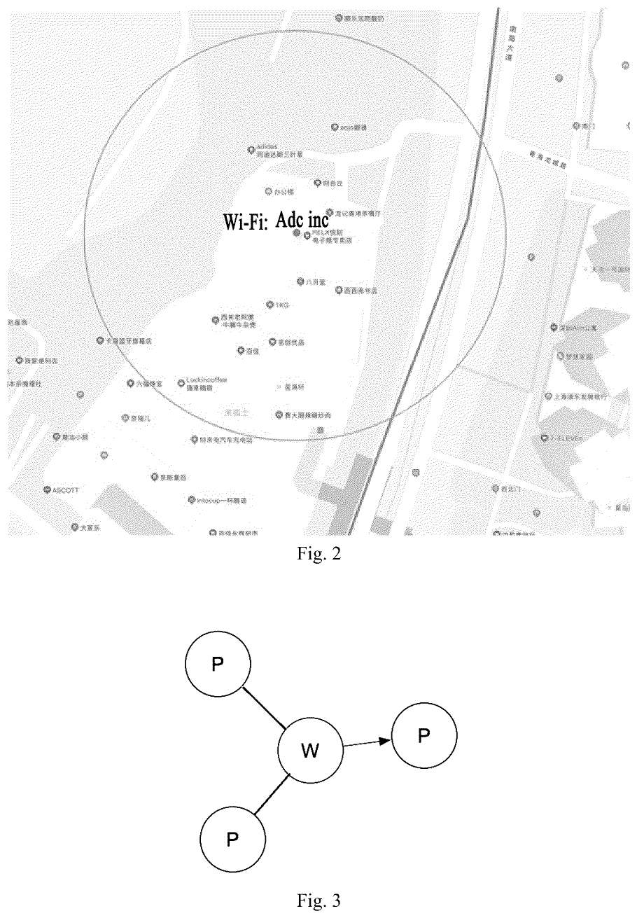

For example, as shown in FIG. 2, there is a Wi-Fi named Adc inc, which is shown on the map as follows. Logic of recall is like drawing a circle, which associates all surrounding POIs with the Wi-Fi named Adc inc, i.e., all the points of interest to be matched for the Wi-Fi named Adc inc are obtained.

Step 102: calculating relationship matching feature data between each target wireless network and the at least one point of interest to be matched that corresponds to the target wireless network.

The relationship matching feature data may include distance feature data between the target wireless network and the point of interest to be matched, and/or text feature data determined according to the first identification information of the target wireless network and the second identification information of the point of interest to be matched. The text feature data includes at least one selected from the group consisting of character granularity feature data, word granularity feature data and semantic feature data.

It should be noted that the first identification information includes the first name of the target wireless network, the second identification information includes the second name of the point of interest to be matched, and the character granularity feature data includes at least one selected from the group consisting of a proportion of identical characters, a character-level similarity coefficient, a longest common substring and a text editing distance between the first name and the second name. The word granularity feature data includes at least one selected from the group consisting of a proportion of identical words between the first name and the second name, a word-level similarity coefficient, and whether the first name is an alias of the second name. The semantic feature data includes a semantic similarity between the first name and the second name.

It should also be noted that the proportion of identical characters may be a proportion of a number of identical characters in the first name and the second name to a total number of characters in the first name and the second name. When the first name of the target wireless network is “ABC DE” and the second name of the point of interest to be matched is “ABC kad”, the proportion of identical characters may be

$$\frac{3 + 3}{5 + 6} .$$

The character-level similarity coefficient may be a Jaccard similarity coefficient corresponding to characters in the first name and the second name, and the similarity coefficient between the first name and the second name may be calculated in the step 102 by reference to a method for calculating the Jaccard similarity coefficient. The method for calculating the Jaccard similarity coefficient is relatively easy to obtain and will not be repeated in the present disclosure. The longest common substring may be a longest string of identical characters contained in the first name and the second name. For example, the longest common substring between the first name “ABC DE” and the second name “ABC kad” is “ABC”. The text editing distance is a number of edits experienced from the first name to the second name. For example, to edit “ABC DE” to “ABC kad”, it is required to first delete D and delete E, and then enter k, enter a, and enter d, so that the text editing distance corresponding to the first name and the second name is 5.

In addition, the proportion of identical words may be a proportion of a number of identical words in the first name and the second name to a total number of words. For example, the proportion of identical words between the first name “ABC DE” and the second name “ABC kad” is

$$\frac{1 + 1}{2 + 2} .$$

The word-level similarity coefficient may be a Jaccard similarity coefficient corresponding to words in the first name and the second name. In response to the first name being an alias of the second name, data in a field corresponding to the word granularity feature data may be “1” or “T”. In response to the first name is not an alias of the second name, the data in the field corresponding to the word granularity feature data may be “0” or “F”. The semantic similarity between the first name and the second name may be calculated by using a semantic similarity calculation method. For example, a semantic similarity acquisition model may be used, and the first name and the second name are input into the semantic similarity acquisition model to acquire a semantic similarity output by the semantic similarity acquisition model. There are many semantic similarity calculation methods and also many types of semantic similarity acquisition models, which are not limited in the present disclosure.

Step 103: inputting the relationship matching feature data into a preset link prediction model to determine a target point of interest corresponding to the target wireless network.

In the step 103, the relationship matching feature data may be input into the preset link prediction model. An association probability between the target wireless network and each of the at least one point of interest to be matched is calculated based on the preset link prediction model. The association probability between the target wireless network and each of the at least one point of interest to be matched is sorted to determine the target point of interest corresponding to the target wireless network from the at least one point of interest to be matched.

The preset link prediction model may be an Extreme Gradient Boosting (XGBoost) model, or may be another machine learning model. According to the relationship matching feature data, the preset link prediction model may determine the association probability between each target wireless network and each point of interest to be matched that corresponds to the target wireless network, and use a point of interest to be matched that has a largest association probability as the target point of interest.

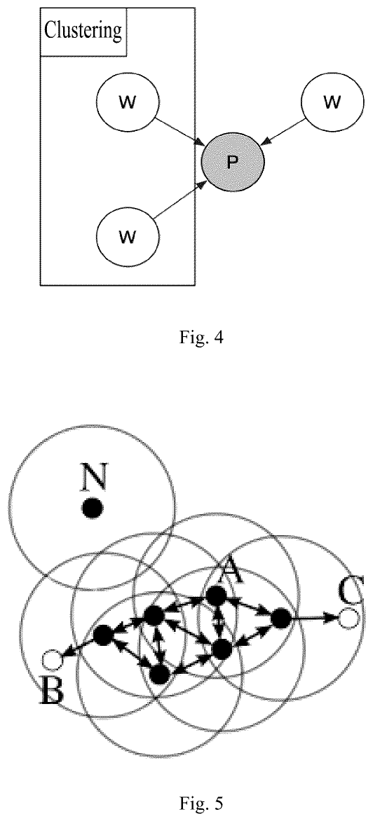

It should be noted that, generally, one Wi-Fi may belong to only one POI. As shown in FIG. 3, although there are a plurality of POIs within a preset range around the Wi-Fi, the preset link prediction model can be used to obtain a target point of interest to which the Wi-Fi belongs.

In addition, the preset link prediction model is obtained through training by: obtaining a plurality of pieces of matching feature sample data, where the matching feature sample data includes at least one selected from the group consisting of distance feature data, character granularity feature data, word granularity feature data, and semantic feature data that correspond to a point of interest sample and a wireless network sample; and training a preset initial model according to the plurality of the pieces of the matching feature sample data to obtain the preset link prediction model.

Step 104: determining at least one of the target wireless networks corresponding to the target point of interest according to the relationship matching feature data and the first identification information of each target wireless network.

In the step 104, the association probability between the target wireless network and each of the at least one point of interest to be matched may be acquired by using the preset link prediction model shown in the step 103; and the at least one of the target wireless networks corresponding to the target point of interest is determined according to the association probability between each target wireless network and the point of interest to be matched.

It should be noted that, generally, there may be a plurality of Wi-Fis for one POI. As shown in FIG. 4, the Wi-Fis around the POI may be clustered by a clustering method to obtain a plurality of clusters (as shown in FIG. 5, whether to cluster nodes together depends on a distance between the nodes, and four clusters are obtained, namely, a cluster N, a cluster A, a cluster B, and a cluster C, where a text similarity between every two adjacent nodes in the cluster A is low), then all Wi-Fis in one of the cluster N, the cluster A, the cluster B, and the cluster C that has a largest average confidence are used as the target wireless networks corresponding to the POI.

In a possible implementation, a target wireless network whose association probability with the target point of interest is greater than a preset association probability threshold may be acquired, thereby obtaining at least one of the target wireless networks corresponding to the target point of interest.

For example, in response to the target point of interest being POI 7 and there being six target points of interest, namely, target points of interest W1 to W6, the association probabilities between the target points of interest W1, W2, W3, W4, W5, and W6 and the target point of interest POI 7 are respectively 0.8, 0.75, 0.75, 0.6, 0.62, and 0.05, and in response to the preset association probability threshold being 0.7, then the W1, W2, W3 are the target wireless networks corresponding to the target point of interest POI 7.

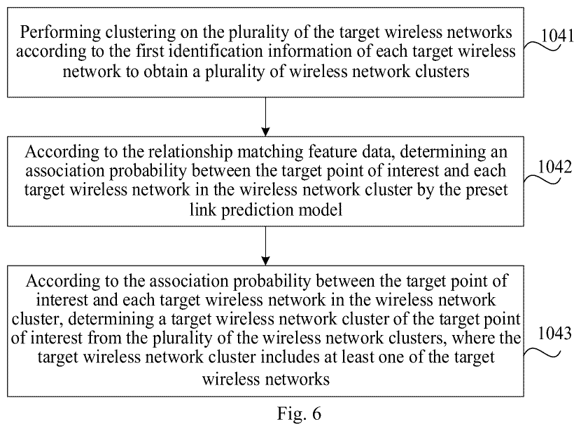

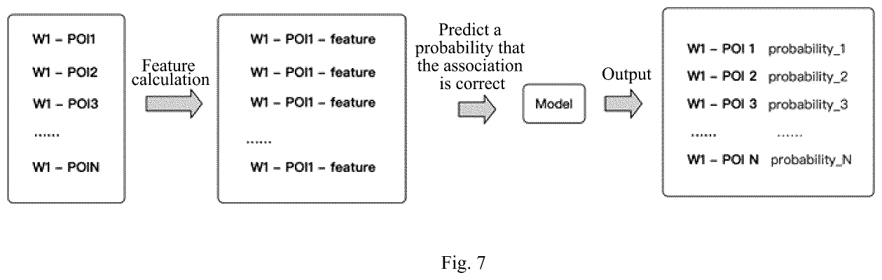

Another possible implementation may be implemented by the method shown in FIG. 6 below. FIG. 6 is a flowchart of a method for data matching according to the embodiment illustrated in FIG. 1 of the present disclosure. As shown in FIG. 6, the determining at least one of the target wireless networks corresponding to the target point of interest according to the relationship matching feature data and the first identification information of each target wireless network, shown in the step 104 in FIG. 1, may include the following steps.

Step 1041: performing clustering on the plurality of the target wireless networks according to the first identification information of each target wireless network to obtain a plurality of wireless network clusters.

The first identification information includes name text and/or Media Access Control Address (MAC) text. When the target wireless network is a Wi-Fi, the name text may be name text of the Wi-Fi, and the MAC text is a MAC address corresponding to the Wi-Fi.

In the step 1041, a clustering algorithm (e.g., DBScan clustering, K-Means clustering, mean shift clustering, etc.) may be used to cluster the plurality of the target wireless networks according to the name text and/or MAC text of each target wireless network, so as to obtain the plurality of the wireless network clusters. It should be noted that the specific clustering process in the step1041 may refer to specific calculation processes of different clustering algorithms, and different clustering algorithms correspond to different clustering processes, which are not repeated in the present disclosure herein.

For example, after inputting the following data into a DBScan clustering algorithm: 30:a2:c2:23:7c: 26-less is more; bc: 54:fc: 14:8c: 7c-wxh; 4c:e9:e4:c6:17:e8-purcotton; 4c:e9:e4:d6:17:e7-purcotton; fc: 2f:ef:f7:e6:60-purcotton; cc: 2f:ef:f7:e7:60-purcotton; b0:95:8e:ed:a6: 49-3d jp; 5c: 71:0d:e2:e3:25-hdlhuoguo; and ac: 4a: 56:44:2b:c5-hdlhuoguo, where the left side of “-” is MAC text of a Wi-Fi, and the right side of “-” is name text of the Wi-Fi, and then, in the DBScan clustering algorithm, clustering is performed according to the MAC text data and name text data of the Wi-Fi, to obtain the final results.

Cluster 1:4c:e9:e4:c6:17:e8-purcotton; 4c:e9:e4:d6:17:e7-purcotton; fc: 2f:ef:f7:e6:60-purcotton; and cc: 2f:ef:f7:e7:60-purcotton.

Cluster 2:5c: 71:0d:e2:e3:25-hdlhuoguo; and ac: 4a: 56:44:2b:c5-hdlhuoguo.

Cluster 3:30:a2:c2:23:7c: 26-less is more.

Cluster 4:bc: 54:fc: 14:8c: 7c-wxh.

Cluster 5:b0:95:8e:ed:a6: 49-3d jp.

Step 1042: according to the relationship matching feature data, determining an association probability between the target point of interest and each target wireless network in the wireless network cluster by the preset link prediction model.

In the step 1042, according to the relationship matching feature data, the association probability between the target wireless network and each of the at least one point of interest to be matched may be calculated by using the preset link prediction model. According to the association probability between each of the plurality of target wireless networks and each of the at least one point of interest to be matched, the association probability between each target wireless network in the wireless network cluster and the target point of interest is determined.

For example, as shown in FIG. 7, FIG. 7 is a schematic diagram of a workflow of a preset link prediction model illustrated by an exemplary embodiment of the present disclosure. The preset link prediction model may output an estimated probability value between the target wireless network and each of the points of interest to be matched. As shown in FIG. 7, after inputting the relationship matching feature data between the target wireless network W1 and each of points of interest to be matched POI 1, POI 2, POI 3, . . . , and POI N, the preset link prediction model outputs an estimated matching probability value (i.e., an association probability) probability_1 between the target wireless network W1 and the point of interest to be matched POI 1, an estimated matching probability value (i.e., an association probability) probability_2 between the target wireless network W1 and the point of interest to be matched POI 2, and an estimated matching probability value (i.e., an association probability) probability_N between the target wireless network W1 and the point of interest to be matched POI N. Similarly, the relationship matching feature data between a target wireless network Wn and each of the points of interest to be matched POI 1, POI 2, POI 3, . . . , and POI N may be input into the preset link prediction model, so as to acquire association probabilities between the target wireless network Wn and the points of interest to be matched POI 1, POI 2, POI 3, . . . , and POI N that are output from the preset link prediction model, thereby obtaining the association probabilities between each target wireless network and the points of interest to be matched.

It should be noted that when the association probabilities between different target wireless networks and each point of interest to be matched are acquired through the step 102, it is equivalent to generating a dataset that includes the association probabilities between the different target wireless networks and each point of interest to be matched. In this step, association probabilities between the target point of interest and each target wireless network in the wireless network cluster may be filtered from the dataset that includes the association probabilities between the different target wireless networks and each point of interest to be matched. For example, for the cluster 1 above, the association probability between W1 (4c:e9:e4:c6:17:e8-purcotton) and POI 1 is 0.8, the association probability between W2 (4c:e9:e4:d6:17:e7-purcotton) and POI 1 is 0.8, the association probability between W3 (fc: 2f:ef:f7:e6:60-purcotton) and POI 1 is 0.85, and the association probability between W4 (cc: 2f:ef:f7:e7:60-purcotton) and POI 1 is 0.83. An association probability between each target wireless network in other wireless network clusters and the target point of interest may also be found.

Step 1043: according to the association probability between the target point of interest and each target wireless network in the wireless network cluster, determining a target wireless network cluster of the target point of interest from the plurality of the wireless network clusters, where the target wireless network cluster includes at least one of the target wireless networks.

In the step 1043, a target association probability between the wireless network cluster and the target point of interest may be determined according to the association probability between each target wireless network in the wireless network cluster and the target point of interest; and a wireless network cluster that has a largest target association probability in the plurality of the wireless network clusters is regarded as the target wireless network cluster.

A possible implementation corresponding to the according to the association probability between the target point of interest and each target wireless network in the wireless network cluster, determining a target association probability between the wireless network cluster and the target point of interest, may include: acquiring a target mean value of the association probability between the target point of interest and the target wireless networks in the wireless network cluster; and regarding the target mean value as the target association probability.

For example, in the cluster 1, the association probability between W1 (4c:e9: e4: c6:17:e8-purcotton) and POI 1 is 0.8, the association probability between W2 (4c:e9:e4:d6:17:e7-purcotton) and POI 1 is 0.8, the association probability between W3 (fc: 2f:ef:f7:e6:60-purcotton) and POI 1 is 0.85, and the association probability between W4 (cc: 2f:ef:f7:e7:60-purcotton) and POI 1 is 0.83. Then, the target association probability between the cluster 1 and the target point of interest POI 1 is

$$\frac{0.8 + 0.8 + 0.85 + 0.83}{4} = 0.82 .$$

Similarly, the target association probability between each cluster in the clustering result and the target point of interest POI 1 may be acquired. For example, the target association probability between the cluster 2 and the target point of interest POI 1 is 0.75, the target association probability between the cluster 3 and the target point of interest POI 1 is 0.70, the target association probability between the cluster 4 and the target point of interest POI 1 is 0.67, and the target association probability between the cluster 5 and the target point of interest POI 1 is 0.55. A wireless network cluster that has a largest target association probability in the plurality of the wireless network clusters is regarded as the target wireless network cluster, and then the cluster 1 is the target wireless network cluster corresponding to the target point of interest POI 1, i.e., W1 (4c:e9:e4:c6:17:e8-purcotton), W2 (4c:e9:e4:d6:17:e7-purcotton), W3 (fc: 2f:ef:f7:e6:60-purcotton), and W4 (cc: 2f:ef:f7:e7:60-purcotton) are all Wi-Fis associated with the target point of interest POI 1.

According to the above technical solution, clustering may be performed on the plurality of the target wireless networks according to the identification text information of each target wireless network to obtain the plurality of wireless network clusters, and then the target wireless network cluster corresponding to the target point of interest is determined according to the association probability between each target wireless network and the target point of interest, so that the plurality of the target wireless networks associated with the target point of interest are acquired. Thus, the plurality of the target wireless networks associated with the target point of interest can be obtained while effectively ensuring the accuracy of the association relationship between the identified point of interest and the wireless network, thereby helping to provide a reliable basis for user services.

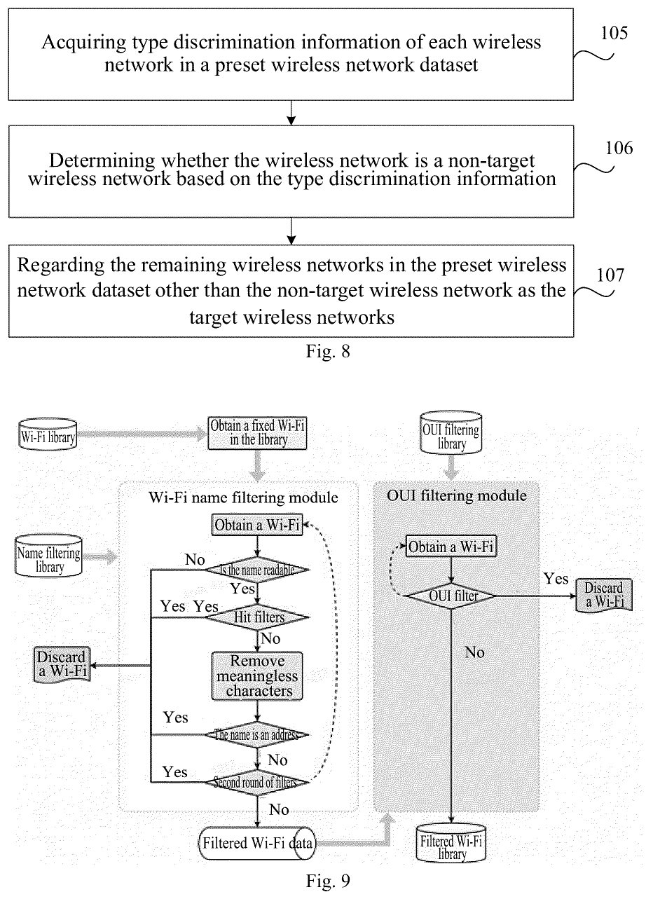

FIG. 8 is a flowchart of a method for data matching according to the embodiment illustrated in FIG. 1 of the present disclosure. As shown in FIG. 8, before the acquiring a target location corresponding to each target wireless network of a plurality of target wireless networks, and at least one point of interest to be matched within a preset range of the target location shown in the step 101 in FIG. 1, the method may further include the following steps.

Step 105: acquiring type discrimination information of each wireless network in a preset wireless network dataset.

The type discrimination information includes identification information and/or location information of the wireless network, and the identification information may be name information, a MAC address, a commercial symbol, etc.

Step 106: determining whether the wireless network is a non-target wireless network based on the type discrimination information.

When the name information includes preset personal information, the Wi-Fi is determined as a non-target wireless network. Alternatively, when the name information includes advertising information, the Wi-Fi is determined as a non-target wireless network. Alternatively, when the location information is unclear (e.g., room-1, room-2, building 1, building 2, etc.), the Wi-Fi is determined as a non-target wireless network.

For example, when the name information and/or location information indicates/indicate that the wireless network is for personal home use, is a mobile hotspot, is an in-vehicle network, is for an apartment hotel, or is an advertising website, or indicates/indicate that the location where the wireless network is located is a non-public location (e.g., a school, an office building, a military site, etc.), the wireless network is determined as a non-target wireless network.

Step 107: regarding the remaining wireless networks in the preset wireless network dataset other than the non-target wireless network as the target wireless networks.

In the step 107, a filter for filtering the non-target wireless network may be generated by using regular expressions. As shown in Table 1 below, the non-target wireless network whose name includes a smart device name, or which indicates personal home use, a mobile hotspot, an in-vehicle network, an apartment hotel, an advertising website, a non-public location, etc., is filtered out.

TABLE 1

| | Rule |
|---|---|
| Filtering rules | classifications |
| \hat{ }skyworth(_[a-f0-9]{4}(_(5\|2\.4)g)?)?$(?# TV brand) | Smart device |
| personal hotspot(?# Clearly indicated as a | Personal |
| personal hotspot) | home use |
| \hat{ }galaxy (a\d+\|capital\|note\|s\d+\|m\d+\|z fold) | Mobile hotspot |
| \hat{ }central control room?(dedicated\|wifi\| | Non-public |
| wireless\|equipment room) | location |
| ([ _-]?5g)?$ | |
| \hat{ }room[ _-]?\d+(_5g)?$ | Apartment hotel |
| \hat{ }install(wifi\|broadband)\d+$ | Advertising |
| | website |

It should be noted that the filtering of the target wireless network is implemented through the steps 105 to 107, and the specific implementation process may be implemented through the implementation shown in FIG. 9. That is, a Wi-Fi name filtering module first discards the Wi-Fi, whose name is unreadable, which hits the first round of filters, and whose name is an address, and which hits second round of filters, so that the filtering module filters out the wireless network whose name includes a smart device name, then an Organizationally Unique Identifier (OUI) filtering module filters out some other wireless networks that indicate personal home use, a mobile hotspot, an in-vehicle network, an apartment hotel, or an advertising website, or belong to a non-public location such as a school, an office building, or a military site, thereby obtaining the target wireless network in a Wi-Fi library.

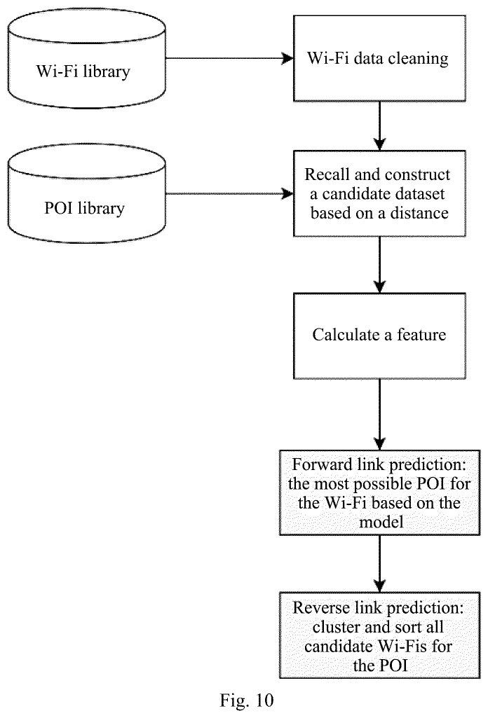

In addition, it should also be noted that the inventive concept of the steps 101 to 107 may be represented by FIG. 10 below. FIG. 10 is a flowchart of the inventive concept according to an exemplary embodiment of the present disclosure, which includes obtaining the target wireless network from the Wi-Fi library via data cleaning (i.e., the process shown in the steps 105 to 107), a process of recalling and constructing a candidate dataset from a POI library according to a distance (specifically shown in the step 101), a calculation process (specifically shown in the step 102), a forward link prediction process (i.e., shown in the step 103), and a reverse link process (i.e., shown in the step 104). Each of the above specific processes has been described in detail in the above embodiments, and will not be repeated in the present disclosure.

According to the above technical solution, the wireless network that not belongs to a point of interest in the preset wireless network dataset may be filtered out, so as to obtain the target wireless network that belongs to the point of interest, thereby help to improve the identification efficiency of identifying the wireless network associated with the point of interest.

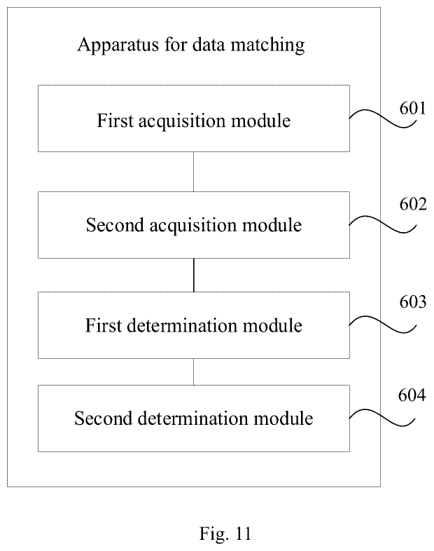

FIG. 11 is a block diagram of an apparatus for data matching illustrated by an exemplary embodiment of the present disclosure. As shown in FIG. 11, the apparatus for data matching may include the first acquisition module 601, the second acquisition module 602, the first determination module 603 and the second determination module 604.

The first acquisition module 601 is configured to acquire a target location of each target wireless network of a plurality of target wireless networks, and at least one point of interest to be matched within a preset range of the target location.

The second acquisition module 602 is configured to calculate relationship matching feature data between each target wireless network and the at least one point of interest to be matched that corresponds to the target wireless network.

The first determination module 603 is configured to input the relationship matching feature data into a preset link prediction model to determine a target point of interest corresponding to the target wireless network.

The second determination module 604 is configured to determine at least one of the target wireless networks corresponding to the target point of interest according to the relationship matching feature data and first identification information of each target wireless network.

According to the above technical solution, the target point of interest corresponding to the target wireless network can be accurately identified, and at least one target wireless network corresponding to the target point of interest can also be effectively acquired, which can effectively improve the identification rate of an association relationship between the target wireless network and the target point of interest, and ensure the accuracy of identification results.

Optionally, the second acquisition module 602 is configured to:
input the relationship matching feature data into the preset link prediction model;
calculate an association probability between the target wireless network and each of the at least one point of interest to be matched based on the preset link prediction model; and
sort the association probability between the target wireless network and each of the at least one point of interest to be matched to determine the target point of interest corresponding to the target wireless network from the at least one point of interest to be matched.

Optionally, the second determination module 604 is configured to:
perform clustering on the plurality of the target wireless networks according to the first identification information of each target wireless network to obtain a plurality of wireless network clusters;
according to the relationship matching feature data, determine an association probability between the target point of interest and each target wireless network in the wireless network cluster by the preset link prediction model; and
according to the association probability between the target point of interest and each target wireless network in the wireless network cluster, determine a target wireless network cluster of the target point of interest from the plurality of the wireless network clusters, where the target wireless network cluster includes at least one of the target wireless networks.

Optionally, the second determination module 604 is configured to:
according to the relationship matching feature data, calculate the association probability between the target wireless network and each of the at least one point of interest to be matched by the preset link prediction model; and
according to the association probability between the plurality of the target wireless networks and each of the at least one point of interest to be matched, determine the association probability between the target point of interest and each target wireless network in the wireless network cluster.

Optionally, the second determination module 604 is configured to:
according to the association probability between the target point of interest and each target wireless network in the wireless network cluster, determine a target association probability between the wireless network cluster and the target point of interest; and
regard a wireless network cluster that has a largest target association probability in the plurality of the wireless network clusters as the target wireless network cluster.

Optionally, the second determination module 604 is configured to:
acquire a target mean value of the association probability between the target point of interest and the target wireless networks in the wireless network cluster; and
regard the target mean value as the target association probability

Optionally, the second acquisition module 602 is configured to:
calculate distance feature data between the target wireless network and the point of interest to be matched;
and/or
determine text feature data according to the first identification information of the target wireless network and the second identification information of the point of interest to be matched, where the text feature data includes at least one selected from the group consisting of character granularity feature data, word granularity feature data, and semantic feature data.

Optionally, the first identification information includes the first name of the target wireless network, the second identification information includes the second name of the point of interest to be matched, and the character granularity feature data includes at least one selected from the group consisting of a proportion of identical characters, a character-level similarity coefficient, a longest common substring and a text editing distance between the first name and the second name.

The word granularity feature data includes at least one selected from the group consisting of a proportion of identical words between the first name and the second name, a word-level similarity coefficient and whether the first name is an alias of the second name.

The semantic feature data includes a semantic similarity between the first name and the second name.

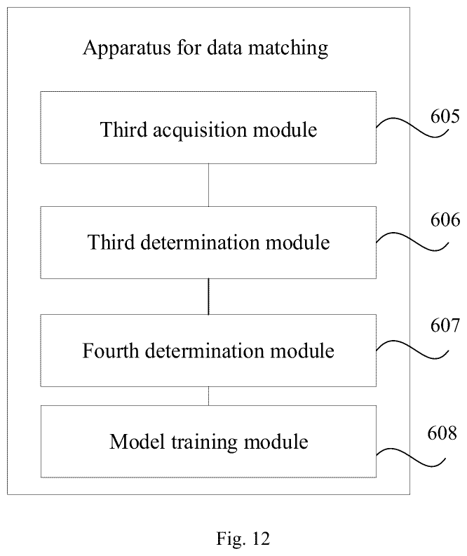

FIG. 12 is a block diagram of an apparatus for data matching according to the embodiment illustrated in FIG. 11 of the present disclosure. As shown in FIG. 12, the apparatus further includes the third acquisition module 605, the third determination module 606 and the fourth determination module 607.

The third acquisition module 605 is configured to acquire type discrimination information of each wireless network in a preset wireless network dataset, where the type discrimination information includes identification information and/or location information of the wireless network.

The third determination module 606 is configured to determine whether the wireless network is a non-target wireless network according to the type discrimination information.

The fourth determination module 607 is configured to regard the remaining wireless networks in the preset wireless network dataset other than the non-target wireless network as the target wireless networks.

Optionally, the apparatus further includes a model training module 608. The model training module 608 is configured to:
acquire a plurality of pieces of matching feature sample data, where the matching feature sample data includes at least one selected from the group consisting of distance feature data, character granularity feature data, word granularity feature data, and semantic feature data that correspond to a point of interest sample and a wireless network sample; and
training a preset initial model according to the plurality of the pieces of the matching feature sample data to obtain the preset link prediction model.

According to the above technical solution, clustering may be performed on the plurality of the target wireless networks according to the identification text information of each target wireless network to obtain the plurality of wireless network clusters, and then the target wireless network cluster corresponding to the target point of interest is determined according to the association probability between each target wireless network and the target point of interest, so that the plurality of the target wireless networks associated with the target point of interest are acquired. Thus, the plurality of the target wireless networks associated with the target point of interest can be obtained while effectively ensuring the accuracy of the association relationship between the identified point of interest and the wireless network, thereby helping to provide a reliable basis for user services.

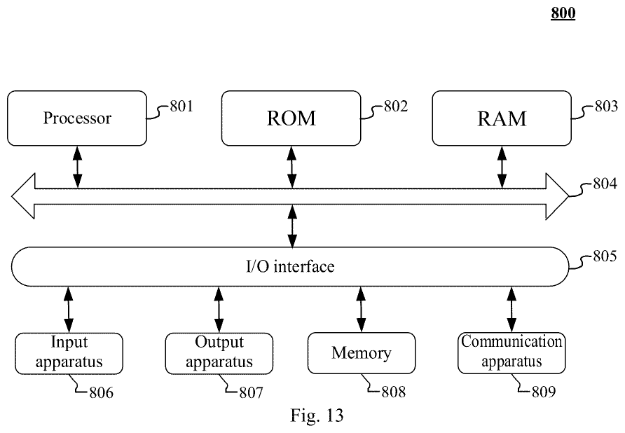

Reference is made to FIG. 13 below, which is a structural schematic diagram of an electronic device 800 suitable for implementing an embodiment of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 13 is merely an example, and shall not impose any limitation on the function and scope of use of the embodiments of the present disclosure.

As shown in FIG. 13, the electronic device 800 may include a processor (e.g., a central processing unit, a graphics processing unit, etc.) 801 that may perform a variety of appropriate actions and processing in accordance with a program stored in a read-only memory (ROM) 802 or a program loaded from a memory 808 into a random access memory (RAM) 803. The RAM 803 further stores various programs and data required for the operation of the electronic device 800. The processor 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touchpad, a keyboard, a mouse, a camera, a microphone, an accelerometer, and a gyroscope; an output apparatus 807 including, for example, a liquid crystal display (LCD), a speaker, and a vibrator; the memory 808 including, for example, a tape and a hard disk; and a communication apparatus 809. The communication apparatus 809 may allow the electronic device 800 to perform wireless or wired communication with other devices to exchange data. Although FIG. 13 shows the electronic device 800 having various apparatuses, it should be understood that it is not required to implement or have all of the shown apparatuses. It may be an alternative to implement or have more or fewer apparatuses.

In particular, according to the embodiments of the present disclosure, the process described above with reference to the flowcharts may be implemented as a computer software program. For example, the embodiments of the present disclosure include a computer program product, which includes a computer program carried on a non-transitory computer-readable medium. The computer program includes program code for performing the method shown in the flowchart. In such an embodiment, the computer program may be downloaded and installed from a network through the communication apparatus 809, or installed from the memory 808, or installed from the ROM 802. When the computer program is executed by the processor 801, the above-mentioned functions defined in the method of the embodiments of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a server may communicate using any currently known or future-developed network protocol such as the HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs. when the one or more programs are executed by the electronic device, the electronic device is caused to: acquire a target location corresponding to each target wireless network of a plurality of target wireless networks, and at least one point of interest to be matched within a preset range of the target location; calculate relationship matching feature data between each target wireless network and the at least one point of interest to be matched that corresponds to the target wireless network; input the relationship matching feature data into a preset link prediction model to determine a target point of interest corresponding to the target wireless network; and determine at least one of the target wireless networks corresponding to the target point of interest according to the relationship matching feature data and first identification information of each target wireless network.

With respect to the apparatus in the above embodiments, the specific manner in which each module performs an operation has been described in detail in the embodiments relating to the method, and will not be detailed herein.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by software, or may be implemented by hardware. Names of the modules do not constitute a limitation on the modules in some cases. For example, the first acquisition module may alternatively be described as “to obtain a target location of each of a plurality of target wireless networks”

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, Example 1 provides a method for data matching. The method includes:
acquiring a target location corresponding to each target wireless network of a plurality of target wireless networks, and at least one point of interest to be matched within a preset range of the target location;
calculating relationship matching feature data between each target wireless network and the at least one point of interest to be matched that corresponds to the target wireless network;
inputting the relationship matching feature data into a preset link prediction model to determine a target point of interest corresponding to the target wireless network; and
determining at least one of the target wireless networks corresponding to the target point of interest according to the relationship matching feature data and first identification information of each target wireless network.

According to one or more embodiments of the present disclosure, Example 2 provides the method of Example 1, where the inputting the relationship matching feature data into a preset link prediction model to determine a target point of interest corresponding to the target wireless network, includes:
inputting the relationship matching feature data into the preset link prediction model;
calculating an association probability between the target wireless network and each of the at least one point of interest to be matched based on the preset link prediction model; and
sorting the association probability between the target wireless network and each of the at least one point of interest to be matched to determine the target point of interest corresponding to the target wireless network from the at least one point of interest to be matched.

According to one or more embodiments of the present disclosure, Example 3 provides the method of Example 1, where the determining at least one of the target wireless networks corresponding to the target point of interest according to the relationship matching feature data and first identification information of each target wireless network, includes:
performing clustering on the plurality of the target wireless networks according to the first identification information of each target wireless network to obtain a plurality of wireless network clusters;
according to the relationship matching feature data, determining an association probability between the target point of interest and each target wireless network in the wireless network cluster by the preset link prediction model; and
according to the association probability between the target point of interest and each target wireless network in the wireless network cluster, determining a target wireless network cluster of the target point of interest from the plurality of the wireless network clusters, where the target wireless network cluster includes at least one of the target wireless networks.

According to one or more embodiments of the present disclosure, Example 4 provides the method of Example 3, where the according to the relationship matching feature data, determining an association probability between the target point of interest and each target wireless network in the wireless network cluster by the preset link prediction model, includes:
according to the relationship matching feature data, calculating the association probability between the target wireless network and each of the at least one point of interest to be matched by the preset link prediction model; and
according to the association probability between the plurality of the target wireless networks and each of the at least one point of interest to be matched, determining the association probability between the target point of interest and each target wireless network in the wireless network cluster.

According to one or more embodiments of the present disclosure, Example 5 provides the method of Example 3, where the according to the association probability between the target point of interest and each target wireless network in the wireless network cluster, determining a target wireless network cluster of the target point of interest from the plurality of the wireless network clusters, includes:
according to the association probability between the target point of interest and each target wireless network in the wireless network cluster, determining a target association probability between the wireless network cluster and the target point of interest; and
regarding a wireless network cluster that has a largest target association probability in the plurality of the wireless network clusters as the target wireless network cluster.

According to one or more embodiments of the present disclosure, Example 6 provides the method of Example 5, where the according to the association probability between the target point of interest and each target wireless network in the wireless network cluster, determining a target association probability between the wireless network cluster and the target point of interest, includes:
acquiring a target mean value of the association probability between the target point of interest and the target wireless networks in the wireless network cluster; and
regarding the target mean value as the target association probability.

According to one or more embodiments of the present disclosure, Example 7 provides the method of Example 1, where the calculating relationship matching feature data between each target wireless network and the at least one point of interest to be matched that corresponds to the target wireless network, includes:
calculating distance feature data between the target wireless network and the point of interest to be matched;
and/or
determining text feature data according to the first identification information of the target wireless network and second identification information of the point of interest to be matched, where the text feature data includes at least one selected from the group consisting of character granularity feature data, word granularity feature data, and semantic feature data.

According to one or more embodiments of the present disclosure, Example 8 provides the method of Example 7, where the first identification information includes a first name of the target wireless network, the second identification information includes a second name of the point of interest to be matched, and the character granularity feature data includes at least one selected from the group consisting of a proportion of identical characters, a character-level similarity coefficient, a longest common substring and a text editing distance between the first name and the second name.

The word granularity feature data includes at least one selected from the group consisting of a proportion of identical words between the first name and the second name, a word-level similarity coefficient and whether the first name is an alias of the second name.

The semantic feature data includes a semantic similarity between the first name and the second name.

According to one or more embodiments of the present disclosure, Example 9 provides the method of any of Examples 1 to 8, where the preset link prediction model is obtained through training by:
acquiring a plurality of pieces of matching feature sample data, where the matching feature sample data includes at least one selected from the group consisting of distance feature data, character granularity feature data, word granularity feature data, and semantic feature data that correspond to a point of interest sample and a wireless network sample; and
training a preset initial model according to the plurality of the pieces of the matching feature sample data to obtain the preset link prediction mode.

According to one or more embodiments of the present disclosure, Example 10 provides an apparatus for data matching. The apparatus includes the first acquisition module, the second acquisition module, the first determination module and the second determination module.

The first acquisition module is configured to acquire a target location of each target wireless network of a plurality of target wireless networks, and at least one point of interest to be matched within a preset range of the target location.

The second acquisition module is configured to calculate relationship matching feature data between each target wireless network and the at least one point of interest to be matched that corresponds to the target wireless network.

The first determination module is configured to input the relationship matching feature data into a preset link prediction model to determine a target point of interest corresponding to the target wireless network.

The second determination module is configured to determine at least one of the target wireless networks corresponding to the target point of interest according to the relationship matching feature data and first identification information of each target wireless network.

According to one or more embodiments of the present disclosure, Example 11 provides a computer-readable medium, which stores a computer program. When the program is executed by a processor, the steps of the method according to any one of Examples 1 to 9 are implemented.

According to one or more embodiments of the present disclosure, Example 12 provides an electronic device. The electronic device includes a memory and a processor. A computer program is stored in the memory.

The processor is configured to execute the computer program in the memory to implement the steps of the method according to any one of Examples 1 to 9.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims. With respect to the apparatus in the above embodiments, the specific manner in which each module performs an operation has been described in detail in the embodiments relating to the method, and will not be detailed herein.

1. A method for data matching, comprising:
acquiring a target location corresponding to each target wireless network of a plurality of target wireless networks, and at least one point of interest to be matched within a preset range of the target location;
calculating relationship matching feature data between each target wireless network and the at least one point of interest to be matched that corresponds to the target wireless network;
inputting the relationship matching feature data into a preset link prediction model to determine a target point of interest corresponding to the target wireless network; and
determining at least one of the target wireless networks corresponding to the target point of interest according to the relationship matching feature data and first identification information of each target wireless network.

2. The method according to claim 1, wherein the inputting the relationship matching feature data into a preset link prediction model to determine a target point of interest corresponding to the target wireless network, comprises:
inputting the relationship matching feature data into the preset link prediction model;
calculating an association probability between the target wireless network and each of the at least one point of interest to be matched based on the preset link prediction model; and
sorting the association probability between the target wireless network and each of the at least one point of interest to be matched to determine the target point of interest corresponding to the target wireless network from the at least one point of interest to be matched.

3. The method according to claim 1, wherein the determining at least one of the target wireless networks corresponding to the target point of interest according to the relationship matching feature data and first identification information of each target wireless network, comprises:
performing clustering on the plurality of the target wireless networks according to the first identification information of each target wireless network to obtain a plurality of wireless network clusters;
according to the relationship matching feature data, determining an association probability between the target point of interest and each target wireless network in the wireless network cluster by the preset link prediction model; and
according to the association probability between the target point of interest and each target wireless network in the wireless network cluster, determining a target wireless network cluster of the target point of interest from the plurality of the wireless network clusters, wherein the target wireless network cluster comprises at least one of the target wireless networks.

4. The method according to claim 3, wherein the according to the relationship matching feature data, determining an association probability between the target point of interest and each target wireless network in the wireless network cluster by the preset link prediction model, comprises:
according to the relationship matching feature data, calculating the association probability between the target wireless network and each of the at least one point of interest to be matched by the preset link prediction model; and
according to the association probability between the plurality of the target wireless networks and each of the at least one point of interest to be matched, determining the association probability between the target point of interest and each target wireless network in the wireless network cluster.

5. The method according to claim 3, wherein the according to the association probability between the target point of interest and each target wireless network in the wireless network cluster, determining a target wireless network cluster of the target point of interest from the plurality of the wireless network clusters, comprises:
according to the association probability between the target point of interest and each target wireless network in the wireless network cluster, determining a target association probability between the wireless network cluster and the target point of interest; and
regarding a wireless network cluster that has a largest target association probability in the plurality of the wireless network clusters as the target wireless network cluster.

6. The method according to claim 5, wherein the according to the association probability between the target point of interest and each target wireless network in the wireless network cluster, determining a target association probability between the wireless network cluster and the target point of interest, comprises:
acquiring a target mean value of the association probability between the target point of interest and the target wireless networks in the wireless network cluster; and
regarding the target mean value as the target association probability.

7. The method according to claim 1, wherein the calculating relationship matching feature data between each target wireless network and the at least one point of interest to be matched that corresponds to the target wireless network, comprises:
calculating distance feature data between the target wireless network and the point of interest to be matched;
and/or
determining text feature data according to the first identification information of the target wireless network and second identification information of the point of interest to be matched, wherein the text feature data comprises at least one selected from the group consisting of character granularity feature data, word granularity feature data, and semantic feature data.

8. The method according to claim 7, wherein the first identification information comprises a first name of the target wireless network, the second identification information comprises a second name of the point of interest to be matched, and the character granularity feature data comprises at least one selected from the group consisting of a proportion of identical characters, a character-level similarity coefficient, a longest common substring and a text editing distance between the first name and the second name;
the word granularity feature data comprises at least one selected from the group consisting of a proportion of identical words between the first name and the second name, a word-level similarity coefficient and whether the first name is an alias of the second name; and
the semantic feature data comprises a semantic similarity between the first name and the second name.

9. The method according to claim 1, wherein the preset link prediction model is obtained through training by:
acquiring a plurality of pieces of matching feature sample data, wherein the matching feature sample data comprises at least one selected from the group consisting of distance feature data, character granularity feature data, word granularity feature data, and semantic feature data that correspond to a point of interest sample and a wireless network sample; and
training a preset initial model according to the plurality of the pieces of the matching feature sample data to obtain the preset link prediction model.

10. (canceled)

11. A non-transient computer-readable medium,
wherein a computer program is stored on the non-transient computer-readable medium, when the computer program is executed by a processor, a method for data matching is implemented, and the method comprises:
acquiring a target location corresponding to each target wireless network of a plurality of target wireless networks, and at least one point of interest to be matched within a preset range of the target location;
calculating relationship matching feature data between each target wireless network and the at least one point of interest to be matched that corresponds to the target wireless network;
inputting the relationship matching feature data into a preset link prediction model to determine a target point of interest corresponding to the target wireless network; and
determining at least one of the target wireless networks corresponding to the target point of interest according to the relationship matching feature data and first identification information of each target wireless network.

12. An electronic device, comprising:
at least one memory, wherein a computer program is stored in the at least one memory; and
at least one processor, configured to execute the computer program in the at least one memory to implement a method for data matching,
wherein the method comprises:
acquiring a target location corresponding to each target wireless network of a plurality of target wireless networks, and at least one point of interest to be matched within a preset range of the target location;
calculating relationship matching feature data between each target wireless network and the at least one point of interest to be matched that corresponds to the target wireless network;
inputting the relationship matching feature data into a preset link prediction model to determine a target point of interest corresponding to the target wireless network; and
determining at least one of the target wireless networks corresponding to the target point of interest according to the relationship matching feature data and first identification information of each target wireless network.

13. The method according to claim 2, wherein the determining at least one of the target wireless networks corresponding to the target point of interest according to the relationship matching feature data and first identification information of each target wireless network, comprises:
performing clustering on the plurality of the target wireless networks according to the first identification information of each target wireless network to obtain a plurality of wireless network clusters;
according to the relationship matching feature data, determining an association probability between the target point of interest and each target wireless network in the wireless network cluster by the preset link prediction model; and
according to the association probability between the target point of interest and each target wireless network in the wireless network cluster, determining a target wireless network cluster of the target point of interest from the plurality of the wireless network clusters, wherein the target wireless network cluster comprises at least one of the target wireless networks.

14. The method according to claim 4, wherein the according to the association probability between the target point of interest and each target wireless network in the wireless network cluster, determining a target wireless network cluster of the target point of interest from the plurality of the wireless network clusters, comprises:
according to the association probability between the target point of interest and each target wireless network in the wireless network cluster, determining a target association probability between the wireless network cluster and the target point of interest; and
regarding a wireless network cluster that has a largest target association probability in the plurality of the wireless network clusters as the target wireless network cluster.

15. The method according to claim 2, wherein the calculating relationship matching feature data between each target wireless network and the at least one point of interest to be matched that corresponds to the target wireless network, comprises:
calculating distance feature data between the target wireless network and the point of interest to be matched;
and/or
determining text feature data according to the first identification information of the target wireless network and second identification information of the point of interest to be matched, wherein the text feature data comprises at least one selected from the group consisting of character granularity feature data, word granularity feature data, and semantic feature data.

16. The method according to claim 3, wherein the calculating relationship matching feature data between each target wireless network and the at least one point of interest to be matched that corresponds to the target wireless network, comprises:
calculating distance feature data between the target wireless network and the point of interest to be matched;
and/or
determining text feature data according to the first identification information of the target wireless network and second identification information of the point of interest to be matched, wherein the text feature data comprises at least one selected from the group consisting of character granularity feature data, word granularity feature data, and semantic feature data.

17. The method according to claim 2, wherein the preset link prediction model is obtained through training by:
acquiring a plurality of pieces of matching feature sample data, wherein the matching feature sample data comprises at least one selected from the group consisting of distance feature data, character granularity feature data, word granularity feature data, and semantic feature data that correspond to a point of interest sample and a wireless network sample; and
training a preset initial model according to the plurality of the pieces of the matching feature sample data to obtain the preset link prediction model.

18. The method according to claim 3, wherein the preset link prediction model is obtained through training by:
acquiring a plurality of pieces of matching feature sample data, wherein the matching feature sample data comprises at least one selected from the group consisting of distance feature data, character granularity feature data, word granularity feature data, and semantic feature data that correspond to a point of interest sample and a wireless network sample; and
training a preset initial model according to the plurality of the pieces of the matching feature sample data to obtain the preset link prediction model.

19. The electronic device according to claim 12, wherein the inputting the relationship matching feature data into a preset link prediction model to determine a target point of interest corresponding to the target wireless network, comprises:
inputting the relationship matching feature data into the preset link prediction model;
calculating an association probability between the target wireless network and each of the at least one point of interest to be matched based on the preset link prediction model; and
sorting the association probability between the target wireless network and each of the at least one point of interest to be matched to determine the target point of interest corresponding to the target wireless network from the at least one point of interest to be matched.

20. The electronic device according to claim 12, wherein the determining at least one of the target wireless networks corresponding to the target point of interest according to the relationship matching feature data and first identification information of each target wireless network, comprises:
performing clustering on the plurality of the target wireless networks according to the first identification information of each target wireless network to obtain a plurality of wireless network clusters;
according to the relationship matching feature data, determining an association probability between the target point of interest and each target wireless network in the wireless network cluster by the preset link prediction model; and
according to the association probability between the target point of interest and each target wireless network in the wireless network cluster, determining a target wireless network cluster of the target point of interest from the plurality of the wireless network clusters, wherein the target wireless network cluster comprises at least one of the target wireless networks.

21. The electronic device according to claim 20, wherein the according to the relationship matching feature data, determining an association probability between the target point of interest and each target wireless network in the wireless network cluster by the preset link prediction model, comprises:
according to the relationship matching feature data, calculating the association probability between the target wireless network and each of the at least one point of interest to be matched by the preset link prediction model; and
according to the association probability between the plurality of the target wireless networks and each of the at least one point of interest to be matched, determining the association probability between the target point of interest and each target wireless network in the wireless network cluster.
